(19) United States
(12) Patent Application Publication
(10) Pub. No.: US 2022/0297348 A1
(43) Pub. Date: Sep. 22, 2022

(54) CONCRETE SAW

(71) Applicant: MILWAUKEE ELECTRIC TOOL CORPORATION, Brookfield, WI (US)

(72) Inventors: Katie M. Kershaw, Milwaukee, WI (US); Patrick D. Gallagher, Oak Creek, WI (US); Matthew N. Lombardo, Muskego, WI (US); Casey A. Ketterhagen, Hartland, WI (US); Allison M. McDougal, Wauwatosa, WI (US); Daryl S. Richards, Sussex, WI (US); John P. Carroll, Brookfield, WI (US); Carissa J. Minkebige, Lake Mills, WI (US); Michael C. Reed, Milwaukee, WI (US); Matthew D. Strommen, Greendale, WI (US)

(21) Appl. No.: 17/699,945

(22) Filed: Mar. 21, 2022

Related U.S. Application Data
(60) Provisional application No. 63/247,849, filed on Sep. 24, 2021.
(60) Provisional application No. 63/222,163, filed on Jul. 15, 2021.
(60) Provisional application No. 63/163,128, filed on Mar. 19, 2021.

(51) Int. Cl. B28D 1/04; B23D 45/00; B23D 45/02; B23D 47/12; H02K 7/14; H02K 11/33

(52) U.S. Cl. CPC B28D 1/045; B23D 45/003; B23D 45/024; B23D 47/12; H02K 7/14; H02K 11/33

(57) ABSTRACT

A concrete saw is disclosed and includes a frame having a platform and a leg pivotably coupled to the platform at a pivot axis, at least two rear wheels coupled to the platform at the pivot axis, at least one rear wheel coupled to an end of the leg distanced from the pivot axis, a power and drive assembly disposed on the platform, wherein the power and drive assembly includes an electric motor and a battery pack coupled to the electric motor to provide direct current power to the electric motor, and a cutting assembly driven by the power and drive assembly to cut a groove in a work surface as the concrete saw is moved across the work surface.

### CROSS-REFERENCE TO RELATED APPLICATIONS

This application claims priority to co-pending U.S. Provisional Patent Application No. 63/163,128 filed on Mar. 19, 2021, the entire content of which is incorporated herein by reference, co-pending U.S. Provisional Patent Application No. 63/222,163 filed on Jul. 15, 2021, the entire content of which is incorporated herein by reference, and co-pending U.S. Provisional Patent Application No. 63/247,849 filed on Sep. 24, 2021, the entire content of which is incorporated herein by reference.

### FIELD OF DISCLOSURE

The present disclosure relates to saws, and in particular to saws operable to cut a groove within a work surface (e.g., concrete).

### SUMMARY

In an embodiment of the invention, a concrete saw is disclosed and includes a frame having a platform and a leg pivotably coupled to the platform at a pivot axis, at least two rear wheels coupled to the platform at the pivot axis, at least one rear wheel coupled to an end of the leg distanced from the pivot axis, a power and drive assembly disposed on the platform, wherein the power and drive assembly includes an electric motor and a battery pack coupled to the electric motor to provide direct current power to the electric motor, and a cutting assembly driven by the power and drive assembly to cut a groove in a work surface as the concrete saw is moved across the work surface.

In another embodiment of the present invention, a concrete saw is disclosed and includes a frame having a platform and a leg pivotably coupled to the platform at a pivot axis, at least two rear wheels coupled to the platform at the pivot axis, at least one rear wheel coupled to an end of the leg distanced from the pivot axis, a power and drive assembly disposed on the platform, wherein the power and drive assembly includes an electric motor and a battery pack coupled to the electric motor to provide direct current power to the electric motor, a cutting assembly driven by the power and drive assembly to cut a groove in a work surface as the concrete saw is moved across the work surface, and a control system operable to selectively control the power and drive assembly, the cutting assembly, or a combination thereof.

In yet another embodiment of the present invention, a concrete saw is disclosed and includes a frame having a platform and a leg pivotably coupled to the platform at a pivot axis, at least two rear wheels coupled to the platform at the pivot axis, at least one rear wheel coupled to an end of the leg distanced from the pivot axis, a power and drive assembly disposed on the platform, wherein the power and drive assembly includes an electric motor and a battery pack coupled to the electric motor to provide direct current power to the electric motor, a cutting assembly driven by the power and drive assembly to cut a groove in a work surface as the concrete saw is moved across the work surface, and a blade depth positioning system that is operable to selectively adjust a depth of the groove cut into the work surface by a cutting blade of the cutting assembly.

Other aspects of the disclosure will become apparent by consideration of the detailed description and accompanying drawings.

### BRIEF DESCRIPTION OF THE DRAWINGS

FIG. 1 is a perspective view of a concrete saw according to one embodiment including a guide arm assembly in an operating position.

FIG. 2 is a perspective view of the concrete saw of FIG. 1 including the guide arm assembly in a storage position.

FIG. 3 is a first side perspective view of a portion of the concrete saw of FIG. 1.

FIG. 4 is a second side perspective view of a portion of the concrete saw of FIG. 1.

FIG. 5 is a rear perspective view of a portion of the concrete saw of FIG. 1.

FIG. 6 is a top view of a portion of a handle assembly of the concrete saw of FIG. 1 including a control interface.

FIG. 7 illustrates a drive assembly of the concrete saw of FIG. 1 operable to drive a cutting blade.

FIG. 8 is a side perspective view of a cutting assembly of the concrete saw of FIG. 1 without a cutting blade coupled to an arbor of the cutting assembly.

FIG. 9 is a side perspective view of the cutting assembly of FIG. 8 including a cutting blade coupled to the arbor.

FIG. 10 is a top perspective view of the arbor of FIG. 8.

FIG. 11 is a side perspective view of a portion of the concrete saw according to another embodiment including a work light coupled to the cutting assembly.

FIG. 12 is a front view of a portion of the concrete saw of FIG. 11.

FIG. 13 is a side perspective view of a portion of the concrete saw of FIG. 1 illustrating a portion of a blade depth positioning assembly.

FIG. 14 is a side view of a portion of the concrete saw of FIG. 1 illustrating the blade depth positioning assembly in a first position.

FIG. 15 is a side view of a portion of the concrete saw of FIG. 1 illustrating the blade depth positioning assembly in a second position.

FIG. 16 is a side view of a portion of the concrete saw of FIG. 1 illustrating the blade depth positioning assembly in a third position.

FIG. 17 illustrates a control system of the concrete saw of FIG. 1.

FIG. 18 is a side perspective view of a portion of the concrete saw of FIG. 1 illustrating a portion of a motor housing removed.

FIG. 19 is a perspective view of the portion of the motor housing of FIG. 18.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and being practiced or being carried out in various ways. Also, it is to be understood that the phraseology and terminology used herein is for the purpose of description and should not be regarded as limiting. Terms of degree, such as “substantially,” “about,” “approximately,” etc. are understood by those of ordinary skill to refer to reasonable ranges outside of the given value, for example, general tolerances associated with manufacturing, assembly, and use of the described embodiments.

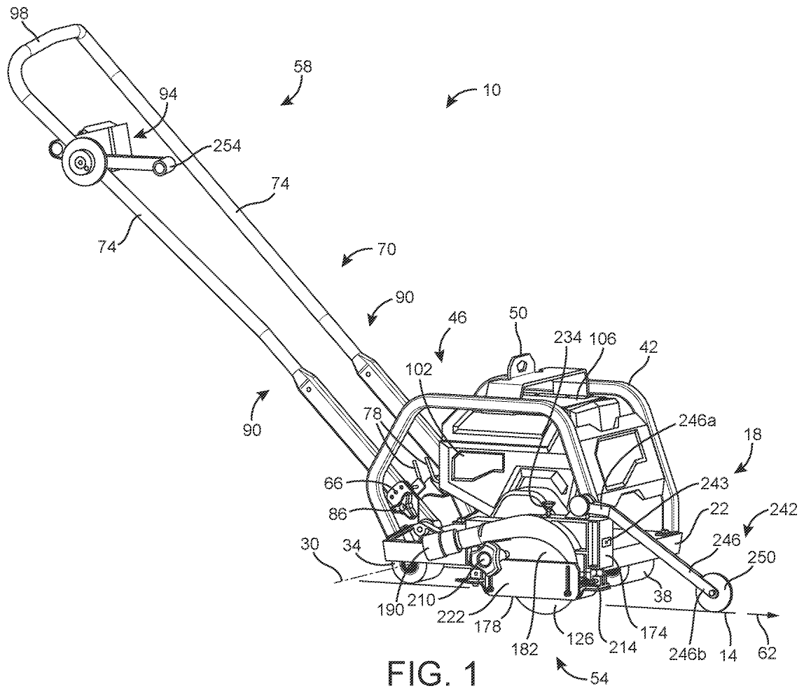

FIGS. 1-5 illustrate an early entry saw (e.g., a concrete saw 10) operable to cut a groove within a work surface 14 (e.g., concrete). The concrete saw 10 includes a frame 18 having a platform 22 pivotably coupled to a leg 26 about a pivot axis 30. The leg 26 is positioned below the platform 22, and in the illustrated embodiment, is within a footprint of the platform 22. In other embodiments, the leg 26 can extend beyond the footprint of the platform 22. The illustrated platform 22 includes at least two rear wheels 34 pivotably coupled about the pivot axis 30, and the illustrated leg 26 includes a front wheel 38 pivotably coupled to an end portion of the leg 26 away from the pivot axis 30. In other embodiments, the leg 26 can include more than one front wheel 38. The wheels 34, 38 are operable to support the concrete saw 10 on the work surface 14. The illustrated frame 18 also includes a cage 42 fixed to the platform 22 to surround a power and drive assembly 46, which is supported on the platform 22, to protect the power and drive assembly 46. For example, the cage 42 protects the power and drive assembly 46 from damage if the concrete saw 10 tips over on its side, protects the power and drive assembly 46 from damage during transportation of the concrete saw 10 to different worksites, etc. In addition, the cage 42 includes a hook 50 located on top of the cage 42 such that the concrete saw 10 can be lifted, for example, onto a trailer to be transported to a different worksite and removed from the trailer on the different worksite. The concrete saw 10 can be lifted and lowered by a chain, cable, etc. coupled between the hook 50 and a machine (e.g., a forklift). Furthermore, a cutting assembly 54 is coupled to a lateral side of the platform 22 and is driven by the power and drive assembly 46 to cut the groove within the work surface 14. The illustrated concrete saw 10 also includes a handle assembly 58 pivotably coupled to a rear side of the platform 22 for an operator to at least push the concrete saw 10 in a forward direction 62 along the work surface 14.

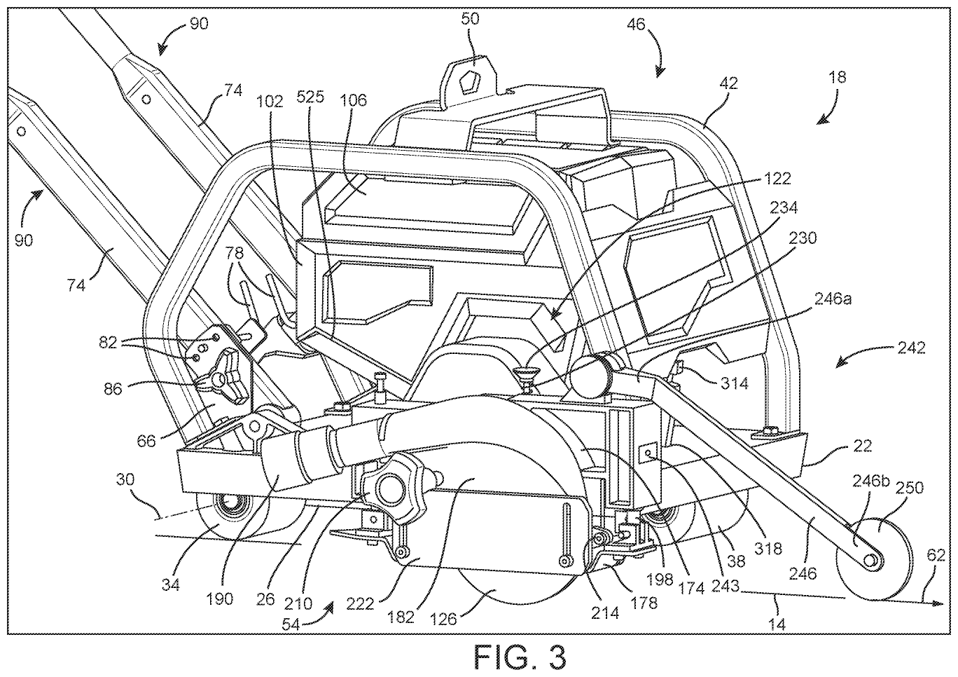

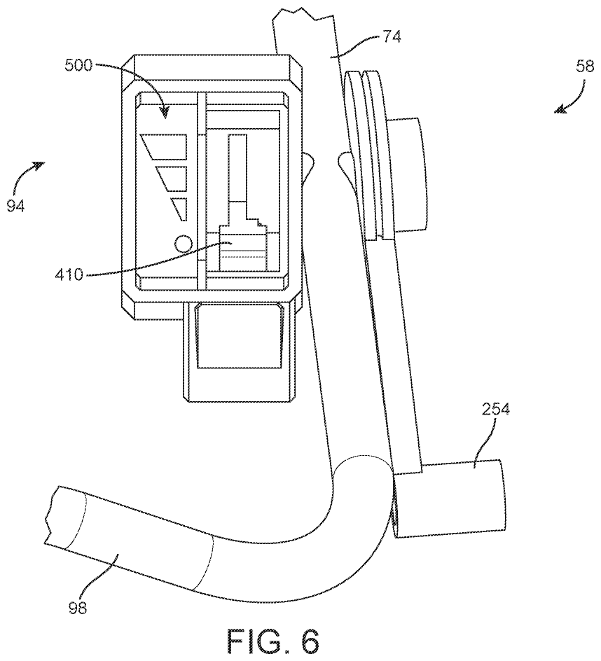

With reference to FIGS. 3-5, the handle assembly 58 includes brackets 66 fixed to the platform 22 and a generally U-shaped handle 70 pivotably coupled to the brackets 66. In the illustrated embodiment, each leg 74 of the handle 70 includes a spring biased handle pin 78 that extends through the leg 74 and one of a plurality of holes 82 formed in the bracket 66. As such, the handle 70 is adjustable in different positions about a pivot axis of the handle assembly 58 by selectively positioning the handle pins 78 in the desired holes 82. In other embodiments, the handle assembly 58 can include one handle pin 78 and/or the handle 70 can include one leg that is pivotably coupled to the platform 22. Also, the handle assembly 58 includes locking knobs 86 (each locking knob 86 associated with one leg 74 of the handle 70) that are rotatable to aid the spring biased handle pins 78 in securing the handle 70 in a desired position relative to the brackets 66. In addition, the handle 70 is selectively collapsible by removing upper portions of the legs 74 from lower portions of the legs 74 at coupling points 90 to reduce the overall size of the handle 70 to aid in storage and/or transportation of the concrete saw 10. As shown in FIGS. 1 and 6, the handle assembly 58 includes a control interface 94 coupled adjacent a gripping portion 98 of the handle 70. The control interface 94 is operable to control and/or indicate different parameters of the power and drive assembly 46 discussed in more detail below. In further embodiments, a length of the handle assembly 58 can be selectively adjustable to best suit the operators needs during operation.

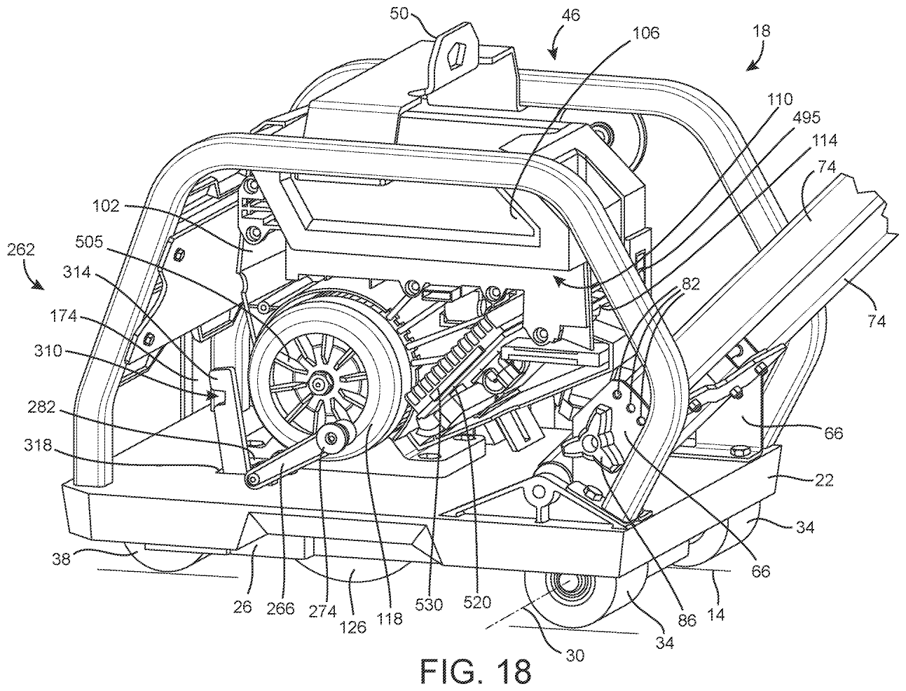

With reference to FIGS. 3-5, the illustrated power and drive assembly 46 includes a motor housing 102 fixed to, or otherwise disposed on, the platform 22 and a battery pack 106 selectively coupled to a battery pack interface or battery receptacle 110 located on top of the motor housing 102. In particular, a battery pack latch 114 is coupled to a rear side of the motor housing 102 to selectively secure the battery pack 106 to the battery receptacle 110 and allow removal of the battery pack 106 from the battery receptacle 110. The motor housing 102 supports an electric motor 118 (FIG. 18) that receives power from the battery pack 106 when the battery pack 106 is coupled to the battery receptacle 110. In the illustrated embodiment, the electric motor 118 is a brushless direct current (BLDC) electric motor. In some constructions, the battery pack 106 and the electric motor 118 can be configured as an 80 Volt high power battery pack and motor, such as the 80 Volt battery pack and motor disclosed in U.S. patent application Ser. No. 16/025,491 filed on Jul. 2, 2018 (now U.S. Patent Application Publication No. 2019/0006980), the entirety of which is incorporated herein by reference. In such a battery pack 106, the battery cells within the battery pack 106 have a nominal voltage of up to about 80 V. Further, in another embodiment, the battery cells within the battery pack 106 have a nominal voltage of up to about 120 V. In some embodiments, the battery pack 106 has a weight of up to about 6 lb. In some embodiments, each of the battery cells has a diameter of up to 21 mm and a length of up to about 71 mm. In some embodiments, the battery cells within the battery pack 106 are cylindrical battery cells, prismatic battery cells, pouch battery cells, or a combination thereof. In some embodiments, the battery pack 106 includes up to twenty battery cells. In other embodiments, the battery pack 106 includes up to thirty battery cells, up to forty battery cells, up to forty-five battery cells, or greater. In some embodiments, the battery cells are disposed in a single pack. In other embodiments, the battery cells are disposed in multiple packs, i.e., two packs, three packs, four packs, etc. In some embodiments, the battery cells are connected in series. In some embodiments, the battery cells are operable to output a sustained operating discharge current of between about 20 A and about 140 A, for example, about 40 A and about 60 A. In some embodiments, each of the battery cells has a capacity of between about 1.7 Ah and about 15.0 Ah. And, in some embodiments of the electric motor 118 when used with the 80 Volt battery pack 106, the electric motor 118 has a power output of at least about 2760 W and a nominal outer diameter (measured at the stator) of up to about 80 mm, up to about 100 mm, up to about 120 mm, up to about 140 mm, or greater. In other embodiments, the concrete saw 10 can include a battery storage compartment to store a spare battery pack as the battery pack 106 powers the electric motor 118.

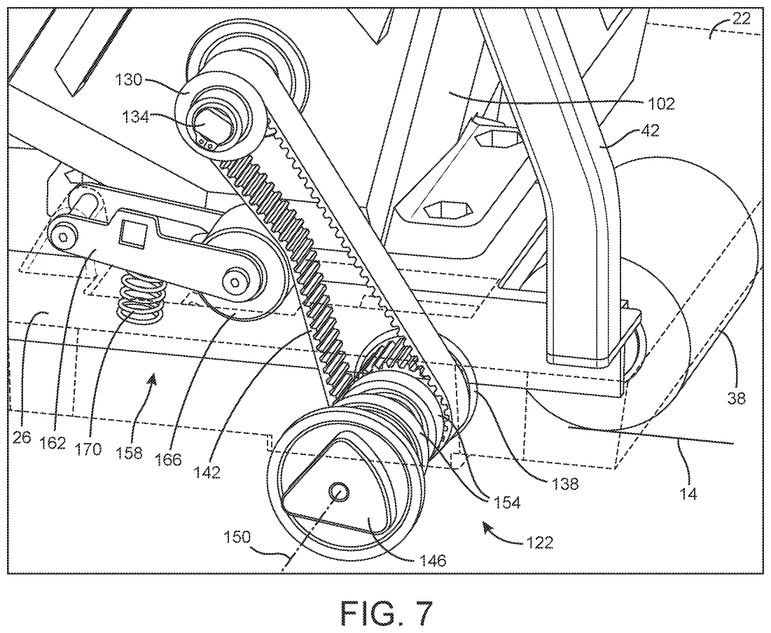

With reference to FIGS. 3 and 7, the concrete saw 10 includes a drive assembly 122 coupled between the electric motor 118 and the cutting assembly 54 for the electric motor 118 to drive a cutting blade 126 of the cutting assembly 54. The illustrated drive assembly 122 includes a drive pulley 130 fixed to a drive shaft 134 of the electric motor 118 that drives a driven pulley 138 by a belt 142. In turn, the driven pulley 138 drives an arbor 146 in which the cutting blade 126 is fixed to about a rotational axis 150. Specifically, the arbor 146 and the driven pulley 138 are supported for rotation about the rotational axis 150 by at least one bearing (e.g., two bearings 154) supported within a bearing pocket of the platform 22. The rotational axis 150 is positioned below an upper surface of the platform 22 that supports the electric motor 118. In addition, the drive assembly 122 includes a belt tensioner 158 having a yoke 162 with a first end portion of the yoke 162 pivotably coupled to the platform 22 and a second end portion of the yoke 162 pivotably coupled to an idler pulley 166. A biasing member 170 (e.g., a compression spring) is coupled between the platform 22 and the yoke 162 to bias the idler pulley 166 into engagement with the belt 142 to provide proper tension on the belt 142 for the belt 142 to drive the arbor 146.

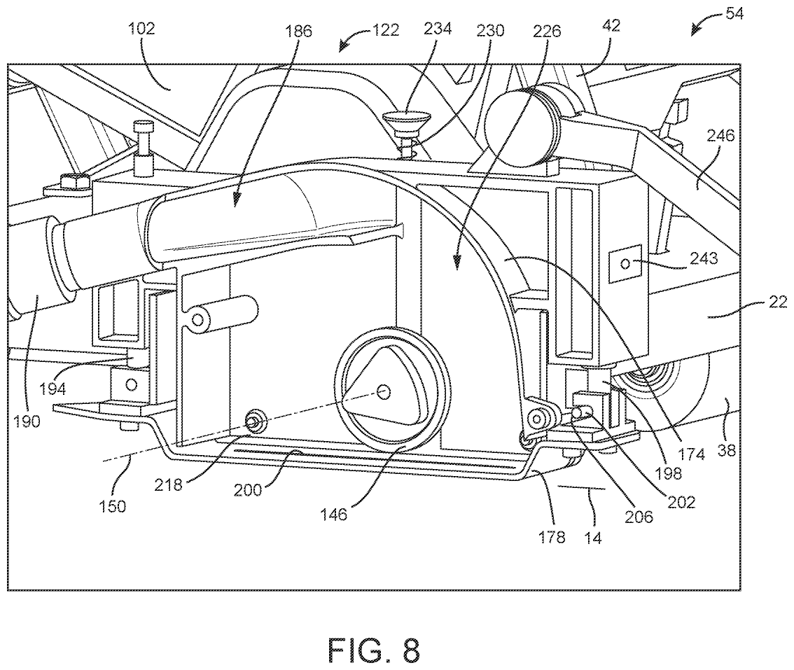

With reference to FIGS. 3, 8, and 9, the cutting assembly 54 includes an inner blade guard 174 fixedly coupled to the platform 22, a pressure plate 178 moveably coupled to the inner blade guard 174, and an outer blade guard 182 removably coupled to the inner blade guard 174. As shown in FIG. 8, the inner blade guard 174 includes a passageway 186 partially defined by a material exhaust fitting 190. The material exhaust fitting 190 can be connectable to a material collection device (e.g., a material collection bag, a material collection vacuum, etc.) to collect particles produced when the cutting blade 126 forms the groove in the work surface 14. With continued reference to FIG. 8, biasing members (e.g., spring-loaded pistons 194, 198) are coupled between the pressure plate 178 and the inner blade guard 174 allowing movement of the pressure plate 178 relative to the inner blade guard 174. The pressure plate 178 includes a slit 200 in which a portion of the cutting blade 126 extends through. The rear spring-loaded piston 194 is pivotably coupled to the pressure plate 178 about an axis, whereas the front spring-loaded piston 198 includes a shaft 202 that is slidable on an oblique surface 206 of the pressure plate 178. The oblique surface 206 is oriented at an oblique angle relative to a surface of the pressure plate 178 that engages the work surface 14. Accordingly, the pressure plate 178 is able to pivot about the axis associated with the rear spring-loaded piston 194 causing the shaft 202 to slide along the oblique surface 206. The spring-loaded pistons 194, 198 bias the pressure plate 178 onto the work surface 14 to apply a constant pressure against the work surface 14 to prevent chipping and spalling as the cutting blade 126 cuts the groove in the work surface 14. With reference back to FIG. 3, the outer blade guard 182 is selectively coupled to the inner blade guard 174 to at least partially enclose a portion of the cutting blade 126 located above the pressure plate 178 by a rotatable outer guard knob 210 and a fastener 214. In addition, an inner side skirt guard 218 is coupled between the inner blade guard 174 and the pressure plate 178 and an outer side skirt guard 222 is coupled between the outer blade guard 182 and the pressure plate 178. The side skirt guards 218, 222 are adjustably slidable relative to the inner blade guard 174 and the outer blade guard 182 to also enclose the portion of the cutting blade 126 located above the pressure plate 178. The side skirt guards 218, 222 are slidable in a direction perpendicular to the rotational axis 150.

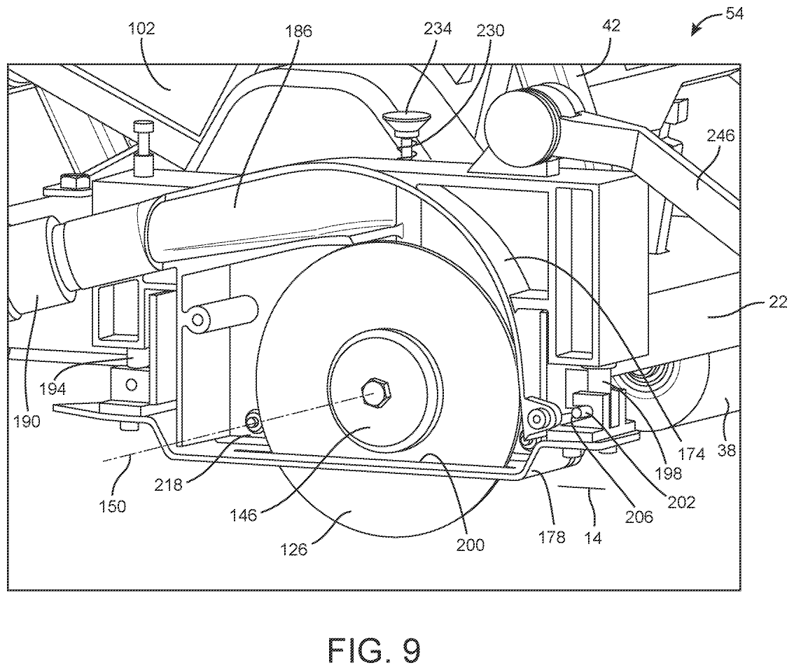

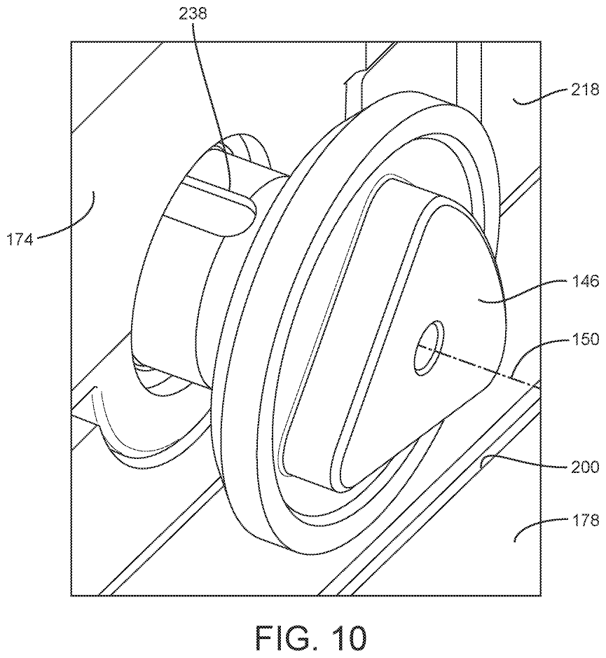

With reference to FIGS. 9 and 10, the concrete saw 10 includes an arbor lock 226 (e.g., a blade changeout system) that selectively fixes the arbor 146 about the rotational axis 150 to facilitate removal and replacement of the cutting blade 126. The arbor lock 226 includes a spring biased pin 230 extending radially from the rotational axis 150 and a knob 234 coupled to the spring biased pin 230. In the illustrated embodiment, the knob 234 is positioned above a top surface of the inner blade guard 174. The spring biased pin 230 extends through the inner blade guard 174 to be selectively engageable with a recess 238 on the arbor 146 (FIG. 10). In the illustrated embodiment, the arbor 146 includes two recesses 238 positioned about 180 degrees apart from each other, but in other embodiments, the arbor 146 can include one recess 238 or more than two recesses 238. To change the cutting blade 126, the outer blade guard 182 is removed from the inner blade guard 174 allowing access to the cutting blade 126 and the arbor 146. In some embodiments, the outer blade guard 182 can be rotated relative to the inner blade guard 174 to allow access to the arbor 146 by loosening or removing the knob 210 and pivoting the outer blade guard 182 about the fastener 214. In a default position of the arbor lock 226, the spring biased pin 230 is biased away from the arbor 146 such that the spring biased pin 230 does not engage the arbor 146. However, to remove an existing cutting blade 126 or tighten a new cutting blade 126 to the arbor 146, the arbor 146 is locked relative to the rotational axis 150. In particular, by pushing the knob 234 downwardly toward the inner blade guard 174/the arbor 146, the spring biased pin 230 engages the recess 238 and locks the arbor 146 from movement about the rotational axis 150. Once the cutting blade 126 is secured to the arbor 146, the knob 234 is released causing the spring biased pin 230 to move out of engagement with the recess 238 back into the default position.

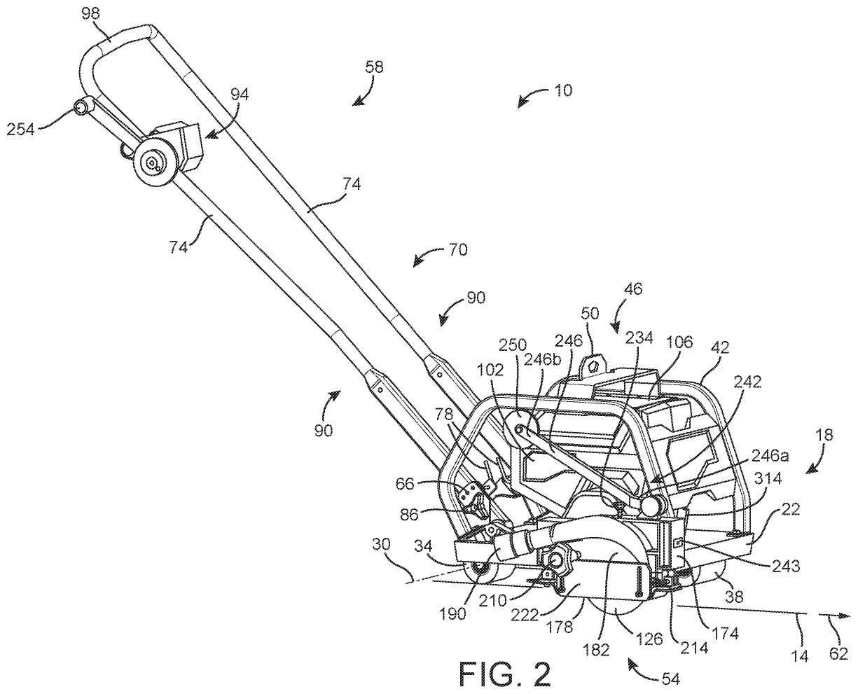

With reference back to FIGS. 2 and 3, the concrete saw 10 also includes a guide arm assembly 242 for aiding an operator in guiding the concrete saw 10 along a straight line across the work surface 14 when cutting the groove. The guide arm assembly 242 includes a guide arm 246 having a proximal end 246a and a distal end 246b. The guide arm 246 is pivotably coupled to the inner blade guard 174 at the proximal end 246a with the guide arm 246 having a guide wheel 250 connected to a distal end 246a of the guide arm 246 so that the guide wheel 250 is selectively engageable with the work surface 14. In particular, a double torsion spring is coupled between the guide arm 246 and the inner blade guard 174 to bias the guide wheel 250 into engagement with the work surface 14 (FIG. 3). The guide arm 246 is also coupled to an actuator (e.g., a lever 254) by a cable. The illustrated lever 254 is coupled to the handle 70 adjacent to the control interface 94. The illustrated guide arm assembly 242 is movable between a storage position (FIG. 2) and an operating position (FIG. 3). In the storage position, the lever 254 provides tension on the cable against the biasing force of the double torsion spring to hold the guide arm 246 in a generally rearwardly extending position (e.g., the guide wheel 250 is spaced apart from the work surface 14). A spring detent is coupled to the lever 254 to assist in holding the lever 254 in the storage position against the biasing force of the double torsion spring. To move the guide arm assembly 242 from the storage position to the operating position, the lever 254 is rotated (e.g., toward the frame 18) allowing the biasing force of the double torsion spring to pivot the guide arm 246 relative to the inner blade guard 174 for the guide wheel 250 to engage the work surface 14. Accordingly, movement of the guide arm 246 is actuated at the handle assembly 58 without the operator moving to the front of the concrete saw 10 and manually moving the guide arm 246 between the storage position and the operating position. In other words, the lever 254 selectively moves the guide arm assembly 242, or the guide arm 246 thereof, between the storage position and the operating position. In other embodiments, the concrete saw 10 can include a laser guide system 243 near the cutting assembly 54, for example on the inner blade guard 174, that would eliminate the need for the guide arm assembly 242 for alignment. In some embodiments, the laser guide system 243 would shine a laser beam down onto a chalk line on the work surface 14 and allow the operator to align the concrete saw 10 in order to cut the groove along a straight path. In other embodiments of the laser guide system 243, the laser would also project out further than the guide arm assembly 242 would allow for better alignment and allow the operator to cut up to an existing wall or form without rotating the guide arm assembly 242 out of the way.

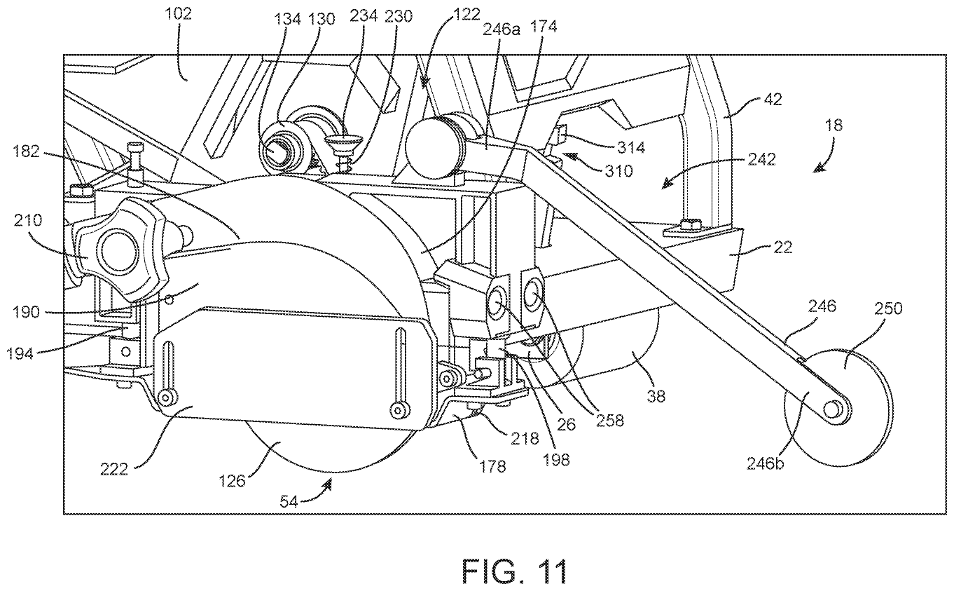

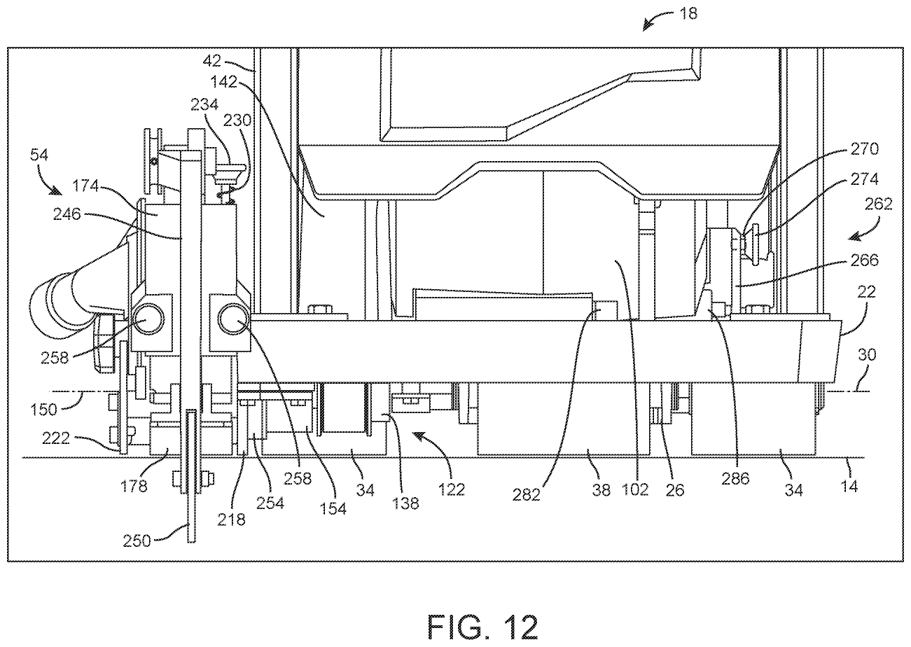

In some embodiments, the concrete saw 10 can include at least one work light 258 coupled to the cutting assembly 54 (FIGS. 11 and 12). In particular, the concrete saw 10 can include two work lights 258 with the guide arm 246 positioned between the work lights 258 in a direction perpendicular to the forward direction 62 (e.g., parallel to the rotational axis 150). The illustrated work lights 258 are angled downwardly toward the work surface 14 from the inner blade guard 174 to illuminate the work surface 14 adjacent the guide wheel 250 when in the operating position. In some embodiments, the work lights 258 can be turned on or off by a switch coupled to the cutting assembly 54 and/or the control interface 94. In other embodiments, the work lights 258 can include a black light, which would illuminate most chalk lines and allow better visibility of the chalk line while cutting the groove.

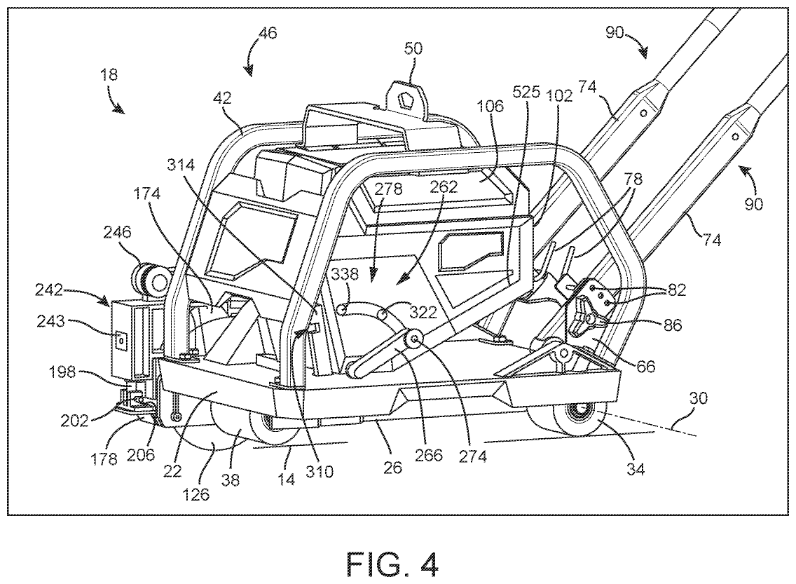

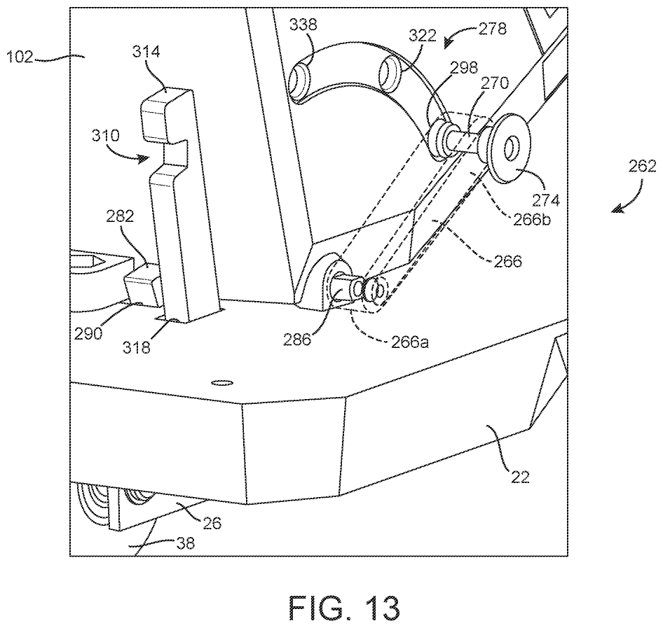

With reference to FIGS. 4 and 13-16, the concrete saw 10 includes a blade depth positioning system 262 operable to adjust a depth of the groove that the cutting blade 126 cuts in the work surface 14. The blade depth positioning system 262 includes an arm 266 having a first end 266a and a second end 266b. The first end 266a of the arm 266 is pivotably coupled to the platform 22 and a spring biased pin 270 is coupled to a knob 274 at the second end 266b. The spring biased pin 270 is axially moveable parallel to the pivot axis of the arm 266 to be selectively positioned within a desired aperture 278 formed in the motor housing 102. In the illustrated embodiment, the motor housing 102 includes three apertures 278 spaced along an arc about the pivot axis of the arm 266. In other embodiments, the motor housing 102 can include more or less than three apertures 278. The arm 266 is fixedly coupled to a cam stop 282 by a shaft 286 that extends through the motor housing 102. The cam stop 282 extends through an opening 290 of the platform 22 to engage a fixed member (e.g., a stud 294) coupled to the leg 26 of the frame 18.

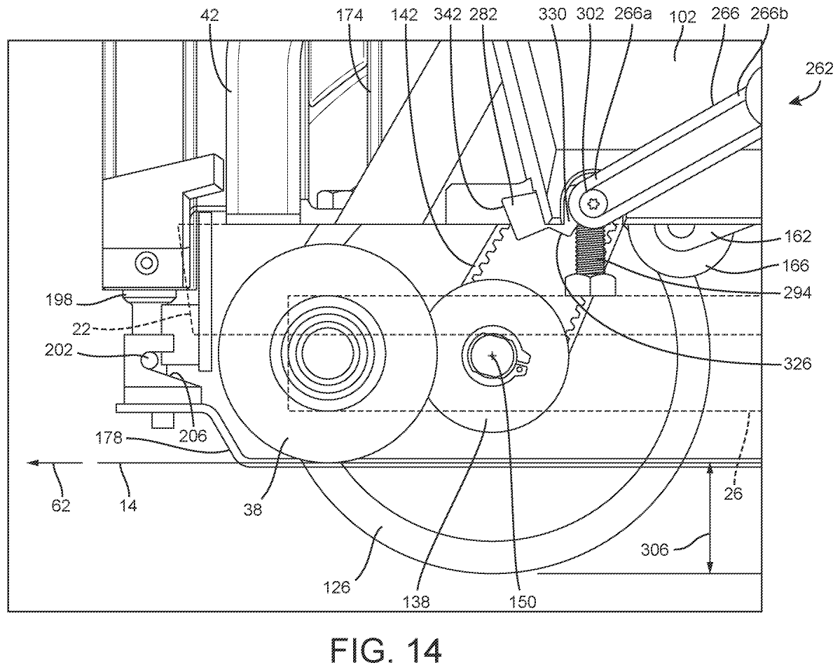

Different engagement positions between the cam stop 282 and the stud 294 causes the platform 22 to be positioned at different angles relative to the leg 26, which ultimately changes the depth of the cutting blade 126 cutting into the work surface 14. Specifically, when the arm 266 is positioned such that the spring biased pin 270 is received within a lowermost aperture 298, the stud 294 engages a first surface 302 of the cam stop 282 (FIG. 14). As a result, the platform 22 is generally parallel with the leg 26 to provide a maximum cutting depth 306 of the cutting blade 126 (e.g., a distance between the bottom surface of the pressure plate 178 and a lowermost apex point of the cutting blade 126). For example, the maximum cutting depth 306 is about 1.5 inches. In addition, the spring-loaded pistons 194, 198 bias the pressure plate 178 into engagement with the work surface 14 when the concrete saw 10 is cutting at the maximum cutting depth 306.

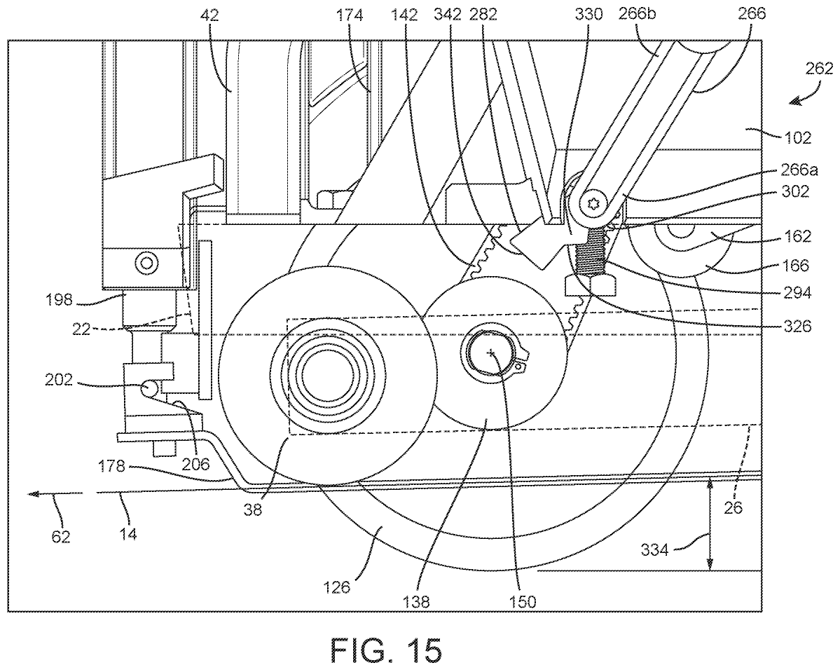

To decrease the cutting depth, the knob 274 is pulled away from the motor housing 102 such that the spring biased pin 270 is spaced from the lowermost aperture 298 allowing the arm 266 to rotate relative to the platform 22. To aid the operator in rotating the arm 266 (as the weight of the power and drive assembly 46 would act against such movement), the platform 22 is first raised for a portion of the platform 22 to engage a notch 310 of a spring biased lever arm 314. The spring biased lever arm 314 holds the platform 22 in this raised position allowing free movement of the arm 266. Specifically, the spring biased lever arm 314 is pivotably coupled to the leg 26 of the frame 18 and extends through an opening 318 of the platform 22 such that the notch 310 engages a bottom surface of the platform 22 to hold the platform 22 in the raised position where the cam stop 282 is spaced from the stud 294. Then, by aligning the spring biased pin 270 with an intermediate aperture 322 and releasing the knob 274, the spring biased pin 270 is received within the intermediate aperture 322. The spring biased lever arm 314 is then pivoted rearwardly against its biasing force for the platform 22 to disengage from the notch 310 to be lowered toward the leg 26. As a result, a second surface 326 of the cam stop 282 defined by a protrusion 330 of the cam stop 282 engages the stud 294 (FIG. 15). The second surface 326 of the stud 294 is positioned radially further than the first surface 302 relative to the pivot axis of the cam stop 282. When the second surface 326 engages the stud 294, the platform 22 is oriented at a first angle relative to the leg 26 (FIG. 15) to set an intermediate depth 334 in which the cutting blade 126 cuts into the work surface 14. For example, the intermediate depth 334 is about 1.18 inches. In addition, the spring-loaded pistons 194, 198 maintain the pressure plate 178 in engagement with the work surface 14 when the concrete saw 10 is cutting at the intermediate cutting depth 334.

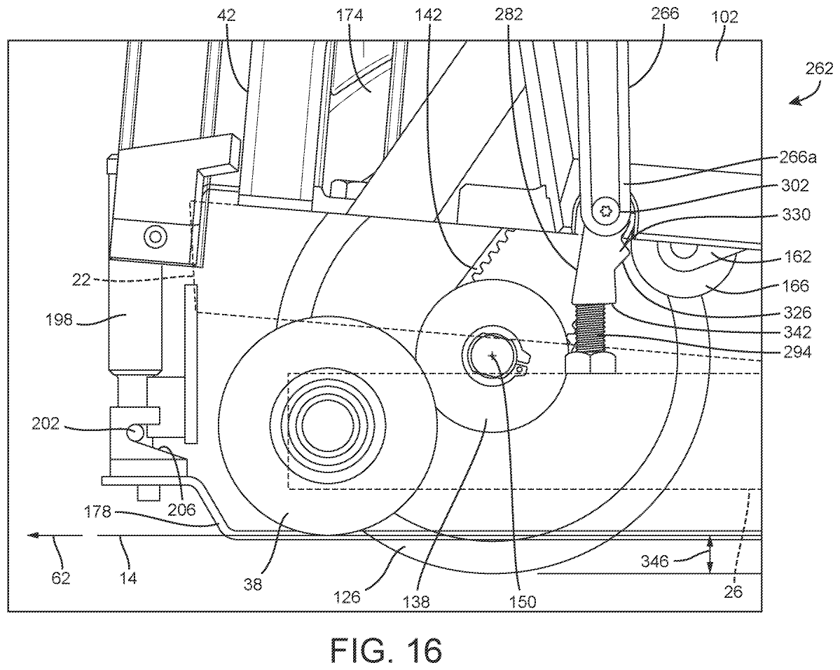

To further decrease the cutting depth, the platform 22 is again raised to engage the notch 310 of the spring biased lever arm 314. The knob 274 is pulled away from the motor housing 102 such that the spring biased pin 270 is spaced from the intermediate aperture 322 allowing the arm 266 to be rotated upwardly away from the platform 22. By aligning the spring biased pin 270 with an uppermost aperture 338 and releasing the knob 274, the spring biased pin 270 is received within the uppermost aperture 338. The spring biased lever arm 314 is pivoted rearwardly against its biasing force for the platform 22 to disengage from the notch 310 to be lowered toward the leg 26. As a result, a third surface 342 of the cam stop 282 defined by an end surface of the cam stop 282 engages the stud 294 (FIG. 16). The third surface 342 of the stud 294 is positioned radially further than the second surface 326 relative to the pivot axis of the cam stop 282. When the third surface 342 engages the stud 294, the platform 22 is oriented at a second angle relative to the leg 26 (FIG. 16) to set a minimum depth 346 in which the cutting blade 126 cuts into the work surface 14. For example, the minimum depth 346 is about 0.5 inches. In addition, the spring-loaded pistons 194, 198 maintain the pressure plate 178 in engagement with the work surface 14 when the concrete saw 10 is cutting at the minimum cutting depth 346. In other embodiments, the blade depth positioning system 262 can include more or fewer than three predetermined depths. In further embodiments, the blade depth positioning system 262 can set the cutting blade depth anywhere between about 0.25 inches to about 2 inches.

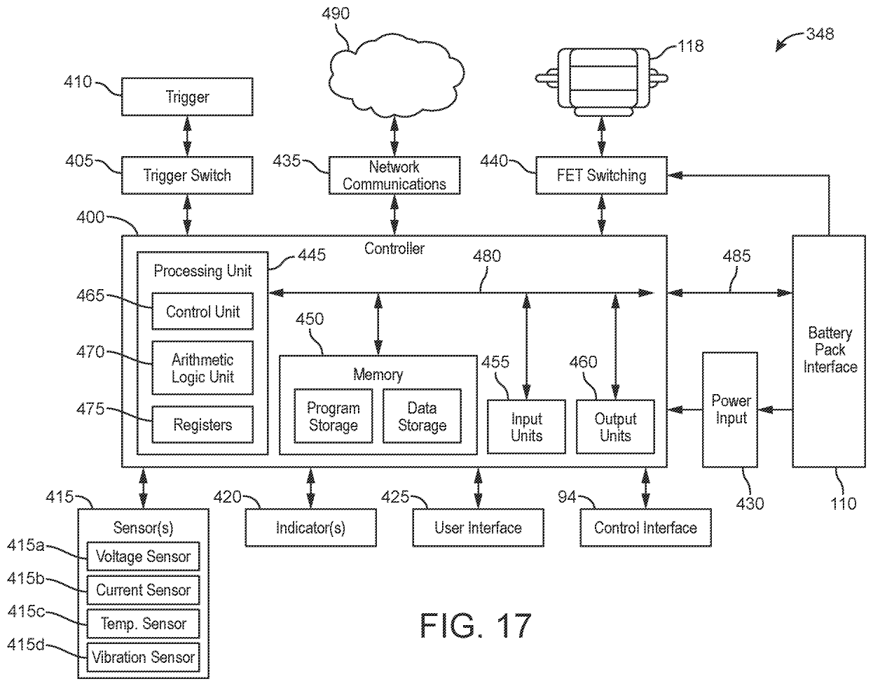

FIG. 17 illustrates a control system 348 for the concrete saw 10. Portions of the control system 348 can be coupled to different locations on the concrete saw 10 to monitor and/or control different aspects of the concrete saw 10. For example, portions of the control system 348 can be coupled to the control interface 94, coupled within the power and drive assembly 46, etc. The illustrated control system 348 includes a controller 400 that is electrically and/or communicatively connected to a variety of modules or components of the concrete saw 10. For example, the illustrated controller 400 is electrically connected to the electric motor 118, the battery pack interface 110, a trigger switch 405 (connected to a trigger 410), one or more sensors or sensing circuits 415, one or more indicators 420, a user interface or user input module 425, a power input module 430, a network communications module 435, and a FET switching module 440 (e.g., including a plurality of switching FETs). The network communications module 435 is connected to a network 490 to enable the controller 400 to communicate with peripheral devices in the network 490, such as a smartphone or a server. The controller 400 includes combinations of hardware and software that are operable to, among other things, selectively control the operation of the concrete saw 10, selectively monitor the operation of the concrete saw 10, selectively activate the one or more indicators 420 (e.g., an LED), selectively control the rotational direction of the cutting blade 126, selectively control the speed of the cutting blade 126, selectively choose a speed mode, selectively measure a linear cutting distance travelled by the cutting blade 126, etc.

The controller 400 includes a plurality of electrical and electronic components that provide power, operational control, and protection to the components and modules within the controller 400 and/or the concrete saw 10. For example, the controller 400 includes, among other things, a processing unit 445 (e.g., a microprocessor, a microcontroller, electronic process, electronic controller, or another suitable programmable device), a memory 450, input units 455, and output units 460. The processing unit 445 includes, among other things, a control unit 465, an arithmetic logic unit (“ALU”) 470, and a plurality of registers 475 (shown as a group of registers in FIG. 17), and is implemented using a known computer architecture (e.g., a modified Harvard architecture, a von Neumann architecture, etc.). The processing unit 445, the memory 450, the input units 455, and the output units 460, as well as the various modules or circuits connected to the controller 400 are connected by one or more control and/or data buses (e.g., common bus 480). The control and/or data buses are shown generally in FIG. 17 for illustrative purposes. The use of one or more control and/or data buses for the interconnection between and communication among the various modules, circuits, and components would be known to a person skilled in the art in view of the disclosure described herein.

The memory 450 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 445 is connected to the memory 450 and executes software instructions that are capable of being stored in a RAM of the memory 450 (e.g., during execution), a ROM of the memory 450 (e.g., on a generally permanent basis), or another non-transitory computer readable medium such as another memory or a disc. Software included in the implementation of the concrete saw 10 can be stored in the memory 450 of the controller 400. The software includes, for example, firmware, one or more applications, program data, filters, rules, one or more program modules, and other executable instructions. The controller 400 is configured to retrieve from the memory 450 and execute, among other things, instructions related to the control processes and methods described herein. In other constructions, the controller 400 includes additional, fewer, or different components.

The battery pack interface 110 includes a combination of mechanical components (e.g., rails, grooves, latches, etc.) and electrical components (e.g., one or more terminals) configured to and operable for interfacing (e.g., mechanically, electrically, and communicatively connecting) the concrete saw 10 with the battery pack 106). For example, power provided by the battery pack 106 to the concrete saw is provided through the battery pack interface 110 to the power input module 430. The power input module 430 includes combinations of active and passive components to regulate or control the power received from the battery pack 106 prior to power being provided to the controller 400. The battery pack interface 110 also supplies power to the FET switching module 440. The battery pack interface 110 also includes, for example, a communication line 485 for providing a communication line or link between the controller 400 and the battery pack 106.

The sensors 415 include, for example, one or more voltage sensors 415a, one or more current sensors 415b, one or more temperature sensors 415c, one or more vibration sensors 415d, etc. The control system 348 uses the one or more sensors to monitor and control the operation of the concrete saw 10. The indicators 420 include, for example, one or more light-emitting diodes (“LEDs”). The indicators 420 can be configured to display conditions of, or information associated with, the concrete saw 10. For example, the indicators 420 are configured to indicate measured electrical characteristics of the concrete saw 10, the status of the concrete saw 10, the status of an operation of the concrete saw 10, etc. The user interface 425 is operably coupled to the controller 400 to, for example, select a forward mode of operation or a reverse mode of operation, a torque and/or speed setting for the concrete saw 10 (e.g., using torque and/or speed switches), etc. In some embodiments, the user interface 425 includes a combination of digital and analog input or output devices required to achieve a desired level of operation for the concrete saw 10, such as one or more knobs, one or more dials, one or more switches, one or more buttons, etc.

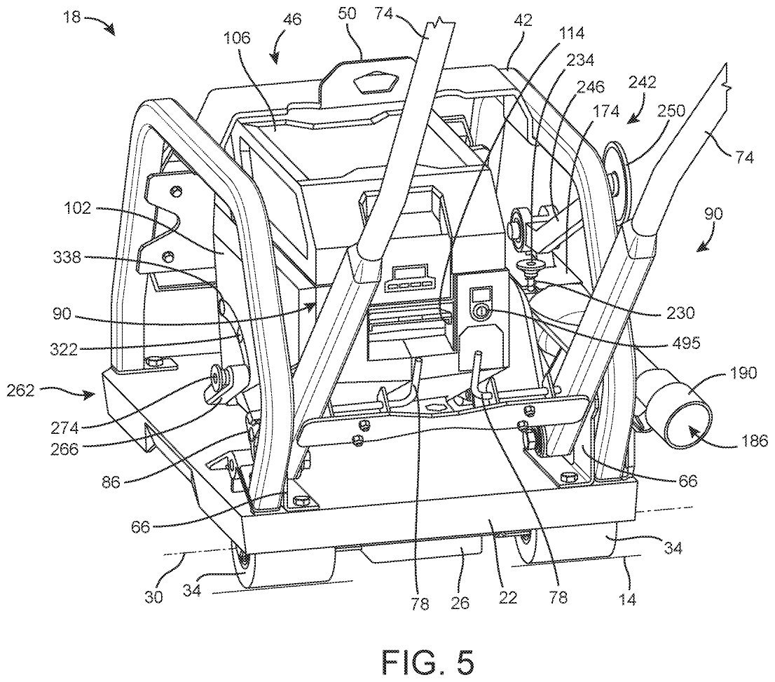

In the illustrated embodiment, the operator of the concrete saw 10 controls operation of the electric motor 118, which ultimately controls operation of the cutting blade 126 by the drive assembly 122, via the control system 348. Specifically, the motor housing 102 includes a current arming switch 495 (e.g., an on/off button) located adjacent the battery pack latch 114 as shown in FIG. 5. In other embodiments, the current arming switch 495 can be coupled to another portion of the concrete saw 10 (e.g., the control interface 94). The current arming switch 495 allows the electric motor 118 to be powered by the battery pack 106. Once the current arming switch 495 is actuated, the speed of the electric motor 118 (and ultimately the speed of the cutting blade 126) is controlled by the trigger 410. In the illustrated embodiment, the trigger 410 is a rotatable speed control lever coupled to the control interface 94 (FIG. 6). The speed control lever 410 is moveable between a first position (as shown in FIG. 6) for the control system 348 to stop operation of the electric motor 118 (e.g., the electric motor 118 does not drive the cutting blade 126) to a second position (not shown but a position furthest from the first position) for the control system 348 to provide maximum power to the electric motor 118 to drive the cutting blade 126 by the drive assembly 122 at a maximum angular velocity. The position of the speed control lever 410 is measured by the trigger switch 405 (e.g., a potentiometer) to control the electric motor 118 to drive the cutting blade 126 within a wide range of desired angular velocities up to the maximum angular velocity. In addition, the control interface 94 includes a display 500 that selectively indicates a status of the power and drive assembly 46 (e.g., the display 500 can indicate a power level of the battery pack 106, a linear cut distance up to a determined distance of the cutting blade 126, strain of the electric motor 118, etc.).

In other embodiments, the control system 348 can drive the electric motor 118 to rotate the cutting blade 126 at half speed for a first distance (e.g., the first 50 feet) that the cutting blade 126 is used. The operator can select a half speed or a full speed setting. If the half-speed setting is selected, the hardware sends a low signal to the micro-control unit (MCU), which indicates to the firmware that the electric motor 118 should be run at half of the full-speed value. If the full-speed setting is selected, the hardware sends a high signal to the MCU, which indicates to the firmware that the electric motor 118 should be run at the full speed value.

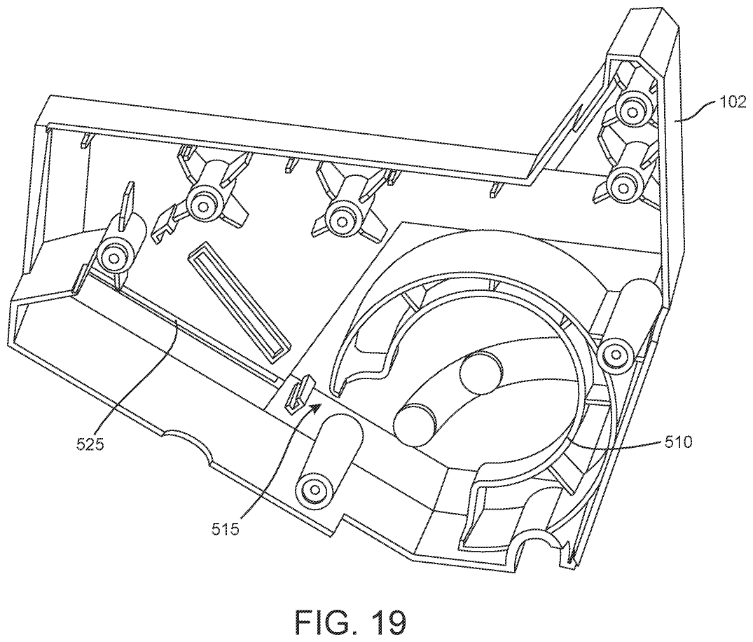

During operation of the electric motor 118, a fan 505 (FIG. 18) of the electric motor 118 rotates to cool the electric motor 118 from overheating. In the illustrated embodiment, at least a portion of an airflow created by the fan 505 is directed to other components of the power and drive assembly 46 to aid in cooling these components. As shown in FIGS. 18 and 19, at least a portion of the fan 505 is received within an inwardly extending arcuate wall 510 of the motor housing 102 that has an opening 515. A printed circuit board (PCB 520) of the control system 348 is fluidly positioned between the opening 515 and exhaust apertures 525 formed in the motor housing 102. In the illustrated embodiment, one exhaust aperture 525 is formed on a first lateral side of the motor housing 102 and another exhaust aperture 525 is formed on a second lateral side of the motor housing 102. Also, the PCB 520 at least supports the FETS 440 of the control system 348 and a fin-style heat sink 530 is coupled to the PCB 520. Accordingly, at least a portion of the airflow created by the fan 505 is directed out of the opening 515 to aid in heat transfer of the fin-style heat sink 530 before exiting the motor housing 102 through the exhaust apertures 525. In other embodiments, at least a portion of the airflow created by the fan 505 can communicate with the battery pack 106 and/or the battery pack receptacle 110 to aid in heat transfer of the thermal energy created by the battery pack 106.

In some embodiments, the concrete saw 10 is maneuvered in position on the work surface 14 when the platform 22 engages the notch 310 of the spring biased lever arm 314. In this orientation, the cutting blade 126 is spaced from the work surface 14 to protect the cutting blade 126 from damage as the concrete saw 10 is moved around prior to cutting into the work surface 14. Also, the operator can set the blade depth using the blade depth positioning system 262 as discussed above. The operator maneuvers the concrete saw 10 to align the cutting blade 126 with a desired line (e.g., a chalk line) on the work surface 14. To initiate operation of the cutting blade 126, the operator actuates the current arming switch 495. In some embodiments, the control system 348 deactivates the electric motor 118 if the operator actuates the current arming switch 495 and the speed control lever 410 is in a non-starting position (e.g., when the speed control lever 410 is positioned from the stop position). As a result, the control system 348 ensures that the cutting blade 126 isn't inadvertently driven when the current arming switch 495 is actuated. If the speed control lever 410 is in a non-starting position when the current arming switch 495 is actuated, the operator can move the speed control lever 410 to the stop position to then move the speed control lever 410 out of the stop position to drive the cutting blade 126.

Once the cutting blade 126 is aligned with the desired line, the platform 22 can be released from the spring biased lever arm 314 and the operator can lower the cutting blade 126 toward the work surface 14 by using the handle assembly 58 to pivot the platform 22 about the pivot axis 30. With a desired speed of the cutting blade 126 determined by the speed control lever 410, the operator continues to lower the cutting blade 126 to plunge into the work surface 14. The cutting blade 126 plunges into the work surface 14 at the desired depth when the cam stop 282 engages the stud 294. At any time when the cutting blade 126 is aligned with the desired line on the work surface 14, the operator can deploy the guide arm 246 to aid in cutting a straight groove. Specifically, the operator rotates the lever 254 forward for the double torsion spring to move the guide arm 246 into the operating position for the guide wheel 250 to engage the work surface 14. The operator then monitors the position of the guide wheel 250 relative to the desired cut line to ensure the concrete saw 10 is cutting a straight groove. Once the cutting blade 126 plunges to the desired depth, the operator can push the concrete saw 10 in the forward direction 62 to cut the groove into the work surface 14. In some embodiments, the concrete saw 10 allows concrete crews to cut control joints in small to medium size slabs on the same day as the concrete is poured. Typically, the concrete saw 10 can be used when the concrete is in the “green” zone, which is about 2-4 hours after the concrete is poured. Also, since the concrete saw 10 is powered by a battery pack 106, this allows operators to safely cut control joints indoors or outdoors and without the use of an extension cord.

In some embodiments, the firmware of the control system 348 of the concrete saw 10 can set the direction of the electric motor 118 to run in a clockwise or counterclockwise direction. When the electric motor 118 direction is set to clockwise, the cutting blade 126 spins in an upcut direction. When the electric motor 118 direction is set to counterclockwise, the cutting blade 126 spins in a downcut direction. In other embodiments of the concrete saw 10, the electric motor 118 direction could also be changed by a signal from an electronic switch. In this case, the firmware is set to rotate the electric motor 118 in the clockwise direction when the switch indicates a forward direction. When the switch indicates a reverse direction, the electric motor 118 changes directions and rotates counterclockwise. In some embodiments, the operator can set a rotational direction of the cutting blade 126 at the control interface 94, motor housing 102, etc. In other embodiments, the cutting blade 126 direction could also be reversed with a mechanical solution, such as a lever. The lever is configured to change the connection of an output shaft of the electric motor 118 through a gear that rotates the cutting blade 126 in the opposite direction of the electric motor 118.

In some embodiments, the control system 348 can monitor an amperage of the battery pack 106. If the battery pack 106 amperage is too high, the battery pack 106 has a possibility to overheat which can shorten battery life. The control system 348 can constantly monitor the amperage, and when the amperage is consistently above a specified threshold, the control system 348 will limit the speed of the electric motor 118, and subsequently the speed of the cutting blade 126. In other embodiments, the control system 348 can include an LED that illuminates concurrently with a speaker projecting a warning sound to alert the operator when the speed of the electric motor 118 is limited. These warning signals will provide the operator with not only a visual cue, but also an audible feedback that they are straining the concrete saw 10. If the operator continues to strain the concrete saw 10 during operation, the concrete saw 10 will continue running at a slower blade speed. Once the operator stops straining the concrete saw 10, the blade speed will return to the normal, nominal operating speed. In other embodiments, the warning signals can include a tactile feedback.

Also, in some embodiments, the control system 348 can include a thermal overload sensor system that includes an electronic monitor for monitoring an internal temperature of the control electronics. When the temperature of the control electronics reaches a specified value, the concrete saw 10 will shut down, causing an LED to illuminate, indicating to the operator that a thermal overload event has occurred. The LED is configured to reset and turn off after an ON/OFF switch (e.g., the current arming switch 495) is cycled, thereby allowing the concrete saw 10 to start up normally. In some embodiments of the thermal overload sensor system, when the tool gets close to the overload temperature, the LED could blink to show that a thermal overload event will happen soon if the operator doesn't let the concrete saw 10 cool down. In other embodiments, there could also be a speaker that plays a warning sound when the concrete saw 10 gets close to the overload temperature.

In further embodiments, the concrete saw 10 can include a distance sensor system that measures a linear distance of the groove being cut into the work surface 14. Typically, concrete saw blade manufacturers recommend that the cutting blade 126 be changed out every 1,000 feet. The distance sensor system is configured to store information related to the linear distance the cutting blade 126 has traveled during operation. The sensor system can include a hall sensor attached to the stationary part of the wheel mount and two magnets, equally spaced, that are attached to one of the wheels 34, 38. When one of the wheels 34, 38 spins, the magnet triggers the hall sensor and sends an electrical signal to a micro control unit (MCU). Typically, when the cutting blade 126 is spinning and performing a cutting action, the amperage peaks at a certain threshold. When the amperage is above the desired threshold and the hall sensor is triggered by the magnet, the distance between the magnets is added to a distance-counter variable. When this distance-counter variable reaches the manufacturer specified value of 1,000 feet, an LED illuminates indicating to the operator that it is time to change the cutting blade 126. To reset this counter back to zero, the operator can press and hold a button. The LED will turn off, indicating that the counter was reset. In other embodiments of the distance sensor system, the hall sensor and magnets can be replaced with a different sensor, such as an optical sensor or a photoresistor. These sensors would also be triggered with the spinning of the wheel 34, 38 and send signals to the MCU similarly as in previous embodiments. In addition, the firmware operation with these sensors would be the same as the hall sensor in the previous embodiments. In some embodiments, a display indicating the linear distance of the groove being cut can be coupled on the motor housing 102 adjacent the current arming switch 495. In other embodiments, the linear distance of the concrete saw 10 can be reset back to zero in response to the operator deactivating the electric motor 118 by the current arming switch 495, and/or the linear distance sensor can be activated to measure the linear distance of the concrete saw 10 in response to the operator activating the electric motor 118 by the current arming switch 495. In further embodiments, the linear distance can be activated and/or deactivated by a switch coupled to the control interface 94. In yet further embodiments, the current arming switch 495 can be actuated a plurality of times in a row (e.g., two times, three times, etc.) or is pressed and held for a period of time to reset the linear distance.

Once the desired groove is cut into the work surface 14, the operator can stop rotation of the cutting blade 126 by moving the speed control lever 254 back to the stop position and deactivate the electric motor 118 by the current arming switch 495. The guide arm 246 can be raised into the storage position by simply rotating the lever 254 rearwardly. The platform 22 can be raised by leveraging the handle assembly 58 for the platform 22 to reengage the notch 310 of the spring biased lever arm 314. And the concrete saw 10 can be transported to a different worksite.

Although the disclosure has been described in detail with reference to certain preferred embodiments, variations and modifications exist within the scope and spirit of one or more independent aspects of the disclosure as described.

Various features of the invention are set forth in the following claims.

What is claimed is:

1. A concrete saw comprising:
a frame having a platform and a leg pivotably coupled to the platform at a pivot axis;
at least two rear wheels coupled to the platform at the pivot axis;
at least one rear wheel coupled to an end of the leg distanced from the pivot axis;
a power and drive assembly disposed on the platform, wherein the power and drive assembly includes an electric motor and a battery pack coupled to the electric motor to provide direct current power to the electric motor; and
a cutting assembly driven by the power and drive assembly to cut a groove in a work surface as the concrete saw is moved across the work surface.

2. The concrete saw of claim 1, further comprising
a handle assembly extending from the platform; and
a control interface coupled to the handle assembly, wherein the control interface controls the operation of the power and drive assembly.

3. The concrete saw of claim 2, further comprising
a cage fixed to the platform and surrounding the power and drive assembly; and
a guide arm assembly extending from the cage, wherein the guide arm assembly includes a pivoting guide arm having a guide wheel attached to an end of the pivoting guide arm and wherein the guide arm assembly is movable between a storage position in which the guide wheel is spaced apart from the work surface and an operating position in which the guide wheel is engaged with the work surface.

4. The concrete saw of claim 3, further comprising
an actuator on the handle assembly, wherein the actuator selectively moves the guide arm assembly between the storage position and the operating position.

5. The concrete saw of claim 1, further comprising
a motor housing, wherein the motor housing includes a battery receptacle for selectively receiving the battery pack therein.

6. The concrete saw of claim 5, wherein the battery pack is removable from the battery receptacle.

7. The concrete saw of claim 1, wherein the motor is a brushless direct current electric motor.

8. A concrete saw, comprising:
a frame having a platform and a leg pivotably coupled to the platform at a pivot axis;
at least two rear wheels coupled to the platform at the pivot axis;
at least one rear wheel coupled to an end of the leg distanced from the pivot axis;
a power and drive assembly disposed on the platform, wherein the power and drive assembly includes an electric motor and a battery pack coupled to the electric motor to provide direct current power to the electric motor;
a cutting assembly driven by the power and drive assembly to cut a groove in a work surface as the concrete saw is moved across the work surface; and
a control system operable to selectively control the power and drive assembly, the cutting assembly, or a combination thereof.

9. The concrete saw of claim 8, wherein the control system is operable to selectively control a rotational direction of a cutting blade of the cutting assembly.

10. The concrete saw of claim 8, wherein the control system is operable to selectively control a speed of a cutting blade of the cutting assembly.

11. The concrete saw of claim 8, wherein the control system is operable to selectively measure a linear cutting distance traveled by a cutting blade of the cutting assembly.

12. The concrete saw of claim 8, wherein the control system further includes one or more sensors to monitor and control operation of the concrete saw.

13. The concrete saw of claim 12, wherein the one or more sensors includes one or more voltage sensors, one or more current sensors, one or more temperature sensors, one or more vibration sensors, or a combination thereof.

14. The concrete saw of claim 8, wherein the control system further includes a control interface operably coupled to the control system and the control interface includes a speed control lever that is operable to selectively control a speed of a cutting blade of the cutting assembly.

15. The concrete saw of claim 14, wherein the control system is operable to selectively provide a full speed setting or a half speed setting for the cutting blade of the cutting assembly.

16. The concrete saw of claim 8, wherein the control system is operable to selectively rotate a cutting blade of the cutting assembly clockwise or counterclockwise.

17. The concrete saw of claim 14, wherein the control interface further includes a display that indicates a status of the power and drive assembly.

18. The concrete saw of claim 16, wherein the display selectively indicates a power level of the battery pack, a linear cut distance of a cutting blade within the cutting assembly, a strain of the electric motor, or a combination thereof.

19. The concrete saw of claim 8, wherein the control system monitors the amperage of the battery pack and selectively limits the speed of the electric motor when the amperage is above a predetermined threshold.

20. The concrete saw of claim 19, wherein the control system further comprises an indicator that selectively illuminates to alert a user that a speed of the electric motor is limited.

21. A concrete saw, comprising:
a frame having a platform and a leg pivotably coupled to the platform at a pivot axis;
at least two rear wheels coupled to the platform at the pivot axis;
at least one rear wheel coupled to an end of the leg distanced from the pivot axis;
a power and drive assembly disposed on the platform, wherein the power and drive assembly includes an electric motor and a battery pack coupled to the electric motor to provide direct current power to the electric motor;
a cutting assembly driven by the power and drive assembly to cut a groove in a work surface as the concrete saw is moved across the work surface; and
a blade depth positioning system that is operable to selectively adjust a depth of the groove cut into the work surface by a cutting blade of the cutting assembly.

22. The concrete saw of claim 21, wherein the blade depth positioning system comprises
an arm having first end pivotably connected to the platform and a second end having a knob coupled thereto, wherein the arm is movable between a plurality of positions to adjust the depth of the cutting blade.

23. The concrete saw of claim 22, wherein the first end of the arm is fixedly coupled to a cam stop via a shaft that extends through first end of the arm, wherein the cam stop engages a stud coupled to the leg, and as the arm is rotated the cam stop moves relative to the stud to cause the platform to be positioned at different angles relative to the leg to change the cutting depth of the cutting blade.

24. The concrete saw of claim 23, wherein the blade depth positioning system further includes a spring biased pin coupled to the knob and extending through the second end of the arm, wherein the spring biased pin selectively engages one of a plurality of apertures formed in a motor housing to prevent the arm from rotating relative to the motor housing.

25. The concrete saw of claim 21, further comprising at least one work light coupled to the cutting assembly and positioned to illuminate a work surface.

26. The concrete saw of claim 25, further comprising a guide arm assembly extending from the frame, wherein the guide arm assembly includes a pivoting guide arm having a guide wheel attached to an end of the pivoting guide arm and wherein the guide arm assembly is movable between a storage position in which the guide wheel is spaced apart from the work surface and an operating position in which the guide wheel is engaged with the work surface and illuminated by the work light when the work light is energized.

27. The concrete saw of claim 21, further comprising a laser guide system placed near the cutting assembly to project a laser beam onto a work surface to assist in aligning the concrete saw on the work surface.
